(19) United States
(12) Patent Application Publication
(10) Pub. No.: US 2021/0237484 A1
(43) Pub. Date: Aug. 5, 2021

(54) METHOD FOR PRODUCING INKJET PRINTED MATERIAL AND INKJET PRINTED MATERIAL

(71) Applicant: NATOCO CO., LTD., Aichi (JP)

(72) Inventors: Katsumi HARA, Miyoshi-shi, Aichi (JP); Takashi ENDO, Miyoshi-shi, Aichi (JP); Makoto WAKAI, Kashiwazaki-shi, Niigata (JP)

(21) Appl. No.: 17/052,977

(22) PCT Filed: Feb. 20, 2019
(86) PCT No.: PCT/JP2019/006385

§ 371 Date: Nov. 4, 2020

(30) Foreign Application Priority Data
May 7, 2018 (JP) 2018-089342

(51) Int. Cl. B41J 11/00; B41M 7/00; B41J 2/21

(52) U.S. Cl. CPC B41J 11/00214; B41J 2/2114; B41M 7/0081

(57) ABSTRACT

A method for producing an inkjet printed material in which a low glossy region having unevenness due to a cured product of a curable inkjet ink is provided on a surface of a glossy base material is provided. The low glossy region is formed by an ink applying step and a curing step, where the ink applying step is a step of applying a liquid droplet of the curable inkjet ink in which a surface tension at 25° C. is 20 to 50 mN/m onto a surface of the base material, and a curing step is a step of curing the liquid droplet of the ink which has been applied onto the surface. Furthermore, an inkjet printed material, in which a low glossy region having unevenness due to a cured product of a curable inkjet ink is provided on a surface of a glossy base material, is provided.

### TECHNICAL FIELD

The present invention relates to a method for producing an inkjet printed material and an inkjet printed material.

### BACKGROUND ART

Various known techniques are known for printing or applying various ink compositions onto a surface of a glossy base material (for example, a surface of a metal base material).

For example, Patent Document 1 discloses a method in which screen printing is performed on a metal or glass substrate with a mirror surface gloss level of 70% or more using a transparent ink of an aqueous emulsion, and thereby a coated film showing a mesh pattern of a screen plate is formed. Patent Document 1 discloses that it is possible to form a pseudo-etched pattern (a pattern that looks as if a base material is etched even though it is not etched) by this method.

Furthermore, Patent Document 2 discloses a method of providing a “masking film” on a metal surface by an inkjet method, that is, a method of forming a coating on a part in which etching needs to be suppressed when etching a metal surface.

Patent Document 2 specifically discloses that a method for producing a masked metal plate, the method including a step of jetting an ink composition containing a polymerizable monomer that can be polymerized by an active energy ray from an inkjet head as ink liquid droplets; a step of landing the jetted ink liquid droplets on a metal surface with a surface tension of 55 to 75 mN/m; and a step of irradiating the landed liquid droplets with an active energy ray to form a masking layer on the metal.

### RELATED DOCUMENT

### Patent Document

[Patent Document 1] Japanese Laid-open Patent Publication No. S52-076114

[Patent Document 2] Japanese Laid-open Patent Publication No. 2011-200763

### SUMMARY OF THE INVENTION

### Technical Problem

There is a demand in the market for a base material having high design properties and including a low glossy region provided by printing an ink composition on a surface of a glossy base material. For example, there is a need for a base material including a low glossy “pseudo-etched pattern” on a surface of the glossy base material, as mentioned in Related Art 1.

Furthermore, it is preferable that such a base material having high design properties can be produced relatively easily.

However, the technique described in Patent Document 1 uses a screen printing technique. Accordingly, it is inferior from the viewpoint of simplicity. In addition, it is not suitable for producing of small amounts of many types of base materials (when attempting to produce base materials having various kinds of patterns, various plates are required, and costs tend to become expensive).

Furthermore, the technique described in Patent Document 2 relates to a “masking layer” in the case of etching. That is, the masking layer of Patent Document 2 is a temporary layer for preventing a part of a metal surface from being etched during etching using a chemical, and it is removed after the etching. In other words, the masking layer itself of Patent Document 2 is not provided from the viewpoint of design properties.

The inventors of the present invention have examined a novel invention, and an object thereof is to provide a method capable of producing a base material including a low glossy region by printing an ink composition on a surface of the glossy base material.

### Solution to Problem

The inventors of the present invention have completed the following inventions as a result of extensive examinations.

According to the present invention, the following is provided.

A method for producing an inkjet printed material in which a low glossy region having unevenness due to a cured product of a curable inkjet ink is provided on a surface of a glossy base material, the method including:

an ink applying step of applying a liquid droplet of the curable inkjet ink in which a surface tension at 25° C. is 20 to 50 mN/m onto a surface of the base material; and

a curing step of curing the liquid droplet of the ink which has been applied onto the surface,

in which the low glossy region is formed by the ink applying step and the curing step.

Furthermore, according to the present invention, the following is provided.

An inkjet printed material, in which a low glossy region having unevenness due to a cured product of a curable inkjet ink is provided on a surface of a glossy base material.

### Advantageous Effects of Invention

The present invention newly provides a producing method capable of producing a base material (inkjet printed material) including a low glossy region by printing an ink composition on a surface of the glossy base material. This producing method is suitable, for example, for producing small amounts of many types of base material.

### BRIEF DESCRIPTION OF THE DRAWINGS

The above-described object, other objects, features, and advantages will be further clarified by preferred embodiments to be described below and the accompanying drawings.

FIG. 1 is a diagram schematically showing an example of a method for producing an inkjet printed material of the present embodiment.

FIG. 2 is an example (photograph) of an inkjet printed material obtained by the method for producing an inkjet printed material of the present embodiment.

FIG. 3 is an example (photograph) of an inkjet printed material obtained by the method for producing an inkjet printed material of the present embodiment.

FIG. 4 is an enlarged image of a “low glossy region” of an inkjet printed material obtained in Example 19.

FIG. 5 is an enlarged image of a “low glossy region” of an inkjet printed material obtained in Example 22.

FIG. 6 is an enlarged image of a “low glossy region” of an inkjet printed material obtained in Example 27.

### DESCRIPTION OF EMBODIMENTS

Hereinafter, embodiments of the present invention will be described in detail with reference to the drawings.

In all the drawings, the same reference numerals are given to the same constituent elements, and the description thereof will not be repeated.

In order to avoid complication, when there are a plurality of the same constituent elements in the same drawing, only one of them may be given a reference numeral, and all of them may not be given a reference numeral.

All the drawings are for illustration purposes only. Shapes and dimensional ratios of the respective members in the drawings do not necessarily correspond to actual articles.

In the present specification, the term “substantially” indicates that it includes a range in which tolerances, assembly variations, and the like in producing are taken into consideration, unless otherwise specified.

In the present specification, the notation “a to b” in the description of a numerical value range represents equal to or more than a and equal to or less than b, unless otherwise specified. For example, “1 to 5 mass %” means “equal to or more than 1 mass % and equal to or less than 5 mass %.”

In the indication of groups (atomic group) in the present specification, the indication not including substitution or unsubstitution includes both groups not having a substituent and groups having a substituent. For example, an “alkyl group” refers not only to an alkyl group not having a substituent (unsubstituted alkyl group) but also to an alkyl group having a substituent (substituted alkyl group).

The expression “(meth)acrylic” in the present specification represents a concept including both acrylic and methacrylic. The same applies to similar notations such as “(meth)acrylate.”

<Method for Producing Inkjet Printed Material>

According to the method for producing an inkjet printed material of the present embodiment, it is possible to produce an inkjet printed material having a low glossy region in which unevenness due to a cured product of the curable inkjet ink are present on the surface of the glossy base material.

The “low glossy region” is formed by an ink applying step and a curing step, where the ink applying step is a step of applying a liquid droplet of the curable inkjet ink in which a surface tension at 25° C. is 20 to 50 mN/m onto a surface of the base material, and a curing step is a step of curing the liquid droplet of the ink which has been applied onto the surface of the base material.

When unevenness is provided on the surface of the glossy base material due to a cured product of the curable inkjet ink, light is scattered by this unevenness. Accordingly, the surface of the glossy base material can be provided with a region having a lower glossiness than that of the base material itself.

Furthermore, it is not necessary to create a “plate” as in the method described in Patent Document 1 (which uses the screen printing technology) by applying the inkjet printing technology in the method for producing an inkjet printed material of the present embodiment. That is, a printed material can be easily produced. In addition, the method is suitable for producing small amounts of many types of printed materials.

Hereinafter, a method for producing an inkjet printed material of the present embodiment will be described in more detail.

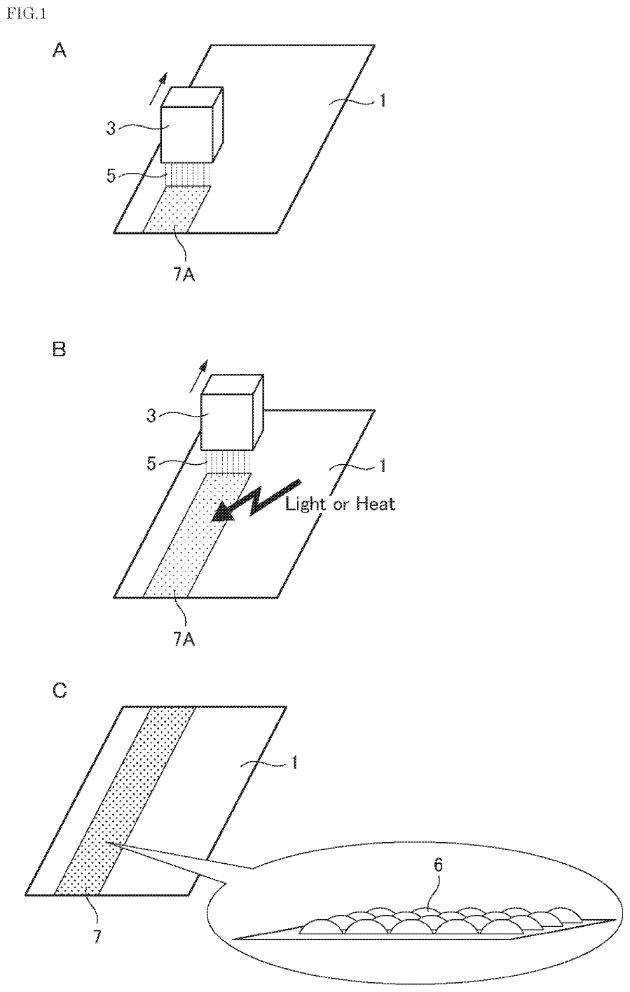

(Ink Applying Step: FIG. 1A)

The method for producing an inkjet printed material of the present embodiment includes an ink applying step of applying a liquid droplet of the curable inkjet ink in which a surface tension at 25° C. is 20 to 50 mN/m onto a surface of the base material (hereinafter, simply referred to as the “ink applying step”).

FIG. 1A is a diagram schematically showing the ink applying step. A liquid droplet 5 of a curable inkjet ink (also simply referred to as the “liquid droplet 5”) is applied from the inkjet head 3 onto a surface of the glossy base material 1 (also simply referred to as the “base material 1”). Thereby, the ink applied region 7A is formed.

The curable inkjet ink used is typically a photocurable type or a thermosetting type. In addition, the curable inkjet ink preferably an ink in which there are substantially no volatilization of a solvent or the like and soaking of the ink into the base material at a stage when the ink is fixed to the base material.

The curable inkjet ink is particularly preferably a photocurable type ink from the viewpoint of simplicity of a process and an apparatus, selectivity of the base material 1 (the base material 1 weak against heat can be used), and the like.

A specific composition, physical properties, and the like of the curable inkjet ink will be described later.

In the ink applying step, the liquid droplets 5 are applied onto the base material 1 at a density of, for example, 1,000 to 100,000 droplets/cm². A density is more preferably 3,000 to 80,000 droplets/cm², and even more preferably 7,000 to 60,000 droplets/cm². By applying the liquid droplet 5 onto the base material 1 at an appropriate density, light scattering properties of a finally obtained inkjet printed material can be appropriately adjusted, and design properties can be further enhanced.

A density (droplets/cm²) of the liquid droplet 5 can be adjusted by appropriately changing a print density in the ink applying step.

A volume of the liquid droplet 5 in the ink applying step (volume of the liquid droplet 5 of every grain) is preferably 2 to 50 pL, more preferably 2 to 42 pL, and even more preferably 3 to 30 pL. By applying the liquid droplet 5 having an appropriate volume onto the base material 1, light scattering properties of a finally obtained inkjet printed material can be appropriately adjusted, which is preferable. In particular, in order to obtain a printed material having pseudo-etched texture and high design properties, a volume of the liquid droplet 5 is preferably 3 to 25 pL, and more preferably 3 to 20 pL.

A volume of the liquid droplet 5 can be changed by changing a setting of an inkjet head 3 or replacing the inkjet head 3 itself.

From the viewpoint of further enhancing design properties of the finally obtained inkjet printed material, it is preferable to appropriately adjust both the volume of the liquid droplet 5 and the density of the liquid droplet 5.

There are various design properties required in the market, and there are various “volumes of the liquid droplets 5” and “densities of the liquid droplets 5” corresponding to required design properties. As an example, the following adjustment is preferable.
In a case where a volume of the liquid droplet 5 is equal to or more than 2 pL and less than 10 pL: 5,000 to 80,000 droplets/cm²
In a case where a volume of the liquid droplet 5 is equal to or more than 10 pL and less than 27 pL: 8,000 to 45,000 droplets/cm²
In a case where a volume of the liquid droplet 5 is equal to or more than 27 pL and less than 50 pL: 1,500 to 35,000 droplets/cm²

The base material 1 is not particularly limited as long as a surface thereof has a certain degree of gloss.

A material of the surface of the base material 1 is preferably at least one selected from the group consisting of metal, synthetic resin, glass, and glossy paper. Among them, metal or glass is particularly preferable.

When the material of the surface of the base material 1 is a metal, specific examples of metals include iron, aluminum, stainless steel, copper, and the like. The material of the surface of the base material 1 is not limited to these examples.

When the material of the surface of the base material 1 is a synthetic resin, the synthetic resin may be a thermoplastic resin or a thermosetting resin. Further specific examples thereof include polyolefin, polyester, polyamide, polyvinyl chloride, polystyrene, polyurethane, ABS resin, acrylic resin, polycarbonate, phenol resin, epoxy resin, melamine resin, urea resin, and the like. Furthermore, the synthetic resin may contain filler particles and the like. The material of the surface of the base material 1 is not limited to these examples.

When the material of the surface of the base material 1 is glass, any known glass can be applied as the glass.

Examples of “glossy paper” of the base material 1 include those known as so-called print paper (also referred to as print sheets, decorative sheet paper, base sheet for decorative sheets, and the like).

There are various types of glossy paper, and there are paper consisting essentially of paper pulp, paper in which resin is added to the base sheet, paper in which resin is impregnated during or after papermaking, paper in which titanium oxide, calcined clay, and the like are added to increase opacity, and the like. Basically, any of these examples may be used. In addition, it is more preferable that the glossy paper have less ink penetration. From this viewpoint, the glossy paper is preferably paper in which resin is added to base sheet, or paper in which resin is impregnated during or after papermaking.

Specific examples of glossy paper and print paper include, but are not limited to, those described in Japanese Laid-open Patent Publication No. 2003-027392, Japanese Laid-open Patent Publication No. 2006-183218, Japanese Laid-open Patent Publication No. 2014-159650, Japanese Laid-open Patent Publication No. 2015-059292, and the like.

The surface of the base material 1 may be subjected to a surface treatment or a cleaning treatment for improving adhesiveness of the liquid droplets 5 or the like. For example, an alkali degreasing treatment may be performed.

A thickness and size of the base material 1 are not particularly limited. They may be appropriately selected depending on usage applications of a finally obtained inkjet printed material, specifications of an inkjet device, and the like.

For convenience of inkjet printing, the base material 1 preferably has a substantially flat shape. However, the base material 1 may have a three-dimensional shape as long as inkjet printing is possible. For example, the base material 1 may be a three-dimensional container or the like.

As the inkjet head 3, any inkjet head can be used as long as it can jet the curable inkjet ink. From the viewpoint of suppressing ink deterioration, a piezo method is preferable.

Examples of commercially available inkjet heads 3 that can be used include KM1024 series produced by Konica Minolta.

A method of moving the inkjet head 3 is not particularly limited as long as the ink is appropriately applied onto the base material 1. The liquid droplet 5 can be applied onto the base material 1 by any method in general inkjet printing, such as a single-pass method, a multi-pass method, or a scan method.

(Curing Step: FIG. 1B)

In the curing step, the liquid droplets 5 of the ink applied onto the surface of the base material 1 in the ink applying step are hardened.

A specific method of curing is appropriately selected depending on properties of the ink applied onto the base material 1. When the applied ink is a photocurable type, the ink applied region 7A is irradiated with light to perform the curing step. Furthermore, when the applied ink is a thermosetting type, the ink applied region 7A is heated to perform curing.

As shown in FIG. 1B, the curing step (specifically, light irradiation or heating) can be started even in the middle of the ink applying step.

When the curing step is performed by light irradiation, an accumulated light amount of radiated light is not particularly limited, and it may be appropriately set depending on photocuring properties (sensitivity) of the ink. From the viewpoint of achieving both shortening of time and sufficient curing, an accumulated light amount of the radiated light is preferably 50 to 10,000 mJ/cm², more preferably 100 to 8,000 mJ/cm², and even more preferably 300 to 5,000 mJ/cm².

A wavelength of light, a light source, and the like are not particularly limited, and they can be appropriately selected depending on photosensitivity of the ink. Typically, light irradiation can be performed using an ultraviolet lamp or the like known in the field of a curable inkjet ink.

In the above-mentioned ink applying step, a time from the application of the liquid droplet 5 onto the surface of the base material 1 to start of the light irradiation step is not particularly limited, but it is preferably 0.1 to 3.0 seconds, and more preferably 0.1 to 1.0 seconds. By setting a time as above, a producing time can be shortened. Furthermore, although details are unknown, it is thought that, by setting a time as above, the liquid droplets 5 applied onto the base material 1 are cured in a shape suitable for light scattering.

When the applied ink is a thermosetting type, the liquid droplet 5 can be cured by heating a base material to which the liquid droplet 5 is applied by arbitrary means such as hot air, an oven, and a hot plate.

For the purpose of further improving adhesiveness of the applied ink (liquid droplet 5), a heat treatment may be performed after the light irradiation. Particularly, when heat resistance of the base material 1 is sufficient (when the base material 1 is a metal base material), it is preferable to perform this treatment (the heat treatment is optional, and there is no problem even when the heat treatment is not performed depending on heat resistance of the base material 1).

For example, the base material after the light irradiation may be heat-treated at 40 to 200° C. for 1 to 60 minutes. The heat treatment can be performed by arbitrary method such as hot air, an oven, and a hot plate.

(Inkjet Printed Material: FIG. 1C)

By performing the above-described ink applying step and curing step (an additional step such as an additional heat treatment or the like may be optionally included), it is possible to produce an inkjet printed material as schematically shown in FIG. 1C.

In FIG. 1C, a low glossy region 7 (also simply referred to as the “low glossy region 7”) is provided on a part of the surface of the base material 1.

The low glossy region 7 has unevenness due to a cured product 6 of the curable inkjet ink (also simply referred to as the “cured product 6”). The cured product 6 is shown enlarged in FIG. 1C.

Because a surface tension of the curable inkjet ink at 25° C. is 20 to 50 mN/m, the liquid droplets 5 applied onto the base material 1 is generally cured into a shape like an inverted bowl (it may be said to be a dome shape, a hemispherical shape, or the like), and thereby a cured product 6 is obtained.

In FIG. 1C, the low glossy region 7 is distributed in a band shape, but by appropriately controlling a region to which the liquid droplets 5 are applied, it is possible to form characters and geometric patterns by the low glossy region 7.

The unevenness of the low glossy region 7 will be described.

The unevenness is not particularly limited as long as it scatters light, but by appropriately controlling the unevenness, it is possible to further enhance design properties of a finally obtained inkjet printed material. For example, it is possible to provide not only low glossiness but also a pattern of pseudo-etched texture.

Specifically, an arithmetic average height Sa of the low glossy region 7 defined by ISO 25178 is preferably 0.05 to 5.0 μm, more preferably 0.2 to 3.0 μm, and even more preferably 0.25 to 2.0 μm. By providing such unevenness, it is possible to further improve design properties of a finally obtained inkjet printed material.

In addition, as another viewpoint, a maximum height Sz defined by ISO 25178 of the low glossy region 7 is preferably 0.5 to 40 μm, more preferably 0.5 to 30 μm, even more preferably 0.5 to 10 μm, particularly preferably 1.0 to 6.0 μm, and most preferably 1.5 to 5.0 μm. By providing such unevenness, it is possible to further improve design properties of a finally obtained inkjet printed material. These numerical value ranges are particularly suitable values when a cationically polymerizable ink to be described later is used as the ink.

From still another viewpoint, when a radically polymerizable ink to be described later is used as the ink, Sz is preferably 10 to 25 μm. Although details are not clear, as findings of the inventors of the present invention, a shape of the cured product 6 when a radically polymerizable ink is used may be slightly different from that when other inks are used. It is presumed that this is related to that design properties can be further improved by setting Sz to 10 to 25 μm.

Sa and Sz can be measured using, for example, a commercially available 3D measuring laser microscope. Specifically, they can be measured using a laser microscope OLS 4100 produced by Shimadzu Corporation.

As one aspect, it is preferable that the cured product of the liquid droplet 5 of the ink do not completely cover the surface of the base material in the low glossy region 7. In other words, the surface of the base material 1 is preferably exposed to some extent even in the low glossy region 7. In this case, it is possible to further enhance design properties (for example, it is easy to obtain an appearance of pseudo-etched texture having higher design properties).

Specifically, when the low glossy region 7 is magnified and observed from directly above the base material 1, it is preferable that 5 to 99% of the base material 1 be covered with a cured product of the liquid droplets 5 in the magnified and observed portion. Furthermore, it is more preferable that 20 to 90% of the base material 1 be covered with a cured product of the liquid droplets 5, and it is even more preferable that 30 to 80% thereof is covered therewith.

The above numerical values can be obtained, for example, by enlarging and imaging an arbitrary portion (square-shaped region) in the low glossy region 7 with a microscope and analyzing the photographed image.

As a reminding description, in the low glossy region 7, a cured product of the ink liquid droplets 5 may completely cover the surface of the base material. A low glossy appearance is realized as long as there is appropriate unevenness due to the cured product of the liquid droplets 5.

As one aspect, the low glossy region 7 has an appearance of pseudo-etched texture.

As explained in the background art, there is a need to provide a pseudo-etched pattern (a pattern that looks as if it is etched even though the base material is not etched) on the surface of the glossy base material. According to the method for producing an inkjet printed material of the present embodiment, it is possible to provide a pseudo-etched pattern on the surface of a base material without creating a plate.

(Curable Inkjet Ink)

Details of the above-described curable inkjet ink (hereinafter, also simply referred to as the “ink”) will be described.

As mentioned above, the ink is typically a photocurable type or a thermosetting type, and it is preferably a photocurable type.

An ink polymerization mode is not particularly limited. A cationically polymerizable type or a radically polymerizable type is preferable, and a cationically polymerizable type is more preferable. According to the findings of the inventors of the present invention, the cationically polymerizable ink tends to have higher adhesiveness to the base material 1 of a cured product of the ink, as compared to the radically polymerizable ink. This is preferable from the viewpoint of durability.

The cationically polymerizable ink typically contains a cationically polymerizable compound and a photocationic polymerization initiator. In addition, other components may be appropriately contained. Composition components of the cationically polymerizable ink will be described below.

Cationically Polymerizable Compound

Typical examples of cationically polymerizable compounds include an oxetane compound, an epoxy compound, a vinylether compound, and the like. Two or more of these may be used in combination. For example, the cationically polymerizable ink may include both an oxetane compound and an epoxy compound.

Examples of epoxy compounds include aromatic epoxides, alicyclic epoxides, aliphatic epoxides, and the like. As the aromatic epoxide, a polyhydric phenol having at least one aromatic ring or its alkylene oxide adduct, or di- or poly-glycidyl ether obtained by reaction with epichlorohydrin is used. Examples thereof include di- or poly-glycidyl ether of bisphenol A or its alkylene oxide adduct, di- or poly-glycidyl ether of hydrogenated bisphenol A or its alkylene oxide adduct, a novolac type epoxy resin, and the like. Examples of alkylene oxides include ethylene oxide, propylene oxide, and the like.

As the epoxy compound, a compound having two or more epoxy groups in one molecule is preferable, and a compound having 2 to 6 epoxy groups in one molecule is more preferable.

As the alicyclic epoxide, a cyclohexene oxide- or cyclopentene oxide-containing compound obtained by epoxidizing a compound having at least one cycloalkane ring such as a cyclohexene ring or a cyclopentene ring with an oxidizing agent such as hydrogen peroxide or a peracid is used.

As the aliphatic epoxide, di- or poly-glycidyl ether of an aliphatic polyhydric alcohol or its alkylene oxide adduct is used. Examples thereof include diglycidyl ether of alkylene glycol, such as diglycidylether of ethylene glycol, diglycidylether of propylene glycol, and diglycidyl ether of 1,6-hexanediol; polyglycidyl ethers of polyhydric alcohols such as di- or tri-glycidyl ethers of glycerin or its alkylene adduct; diglycidyl ether of polyalkylene glycol, such as diglycidyl ether of polyethylene glycol or its alkylene oxide adduct, and diglycidyl ether of polypropylene glycol or its alkylene oxide adduct; and the like. Examples of alkylene oxides include ethylene oxide, propylene oxide, and the like.

Among these epoxides, from the viewpoint of curability, aromatic epoxides or alicyclic epoxides are preferable, and alicyclic epoxides are more preferable.

Regarding an epoxy compound, one kind or two or more kinds thereof can be selected suitably and used.

The oxetane compound is preferably a compound having 1 to 4 oxetane rings in one molecule, and is more preferably a compound having 2 to 4 oxetane rings in one molecule.

Specific examples of oxetane compounds include 3-ethyl-3-[[(3-ethyloxetane-3-yl)methoxy]methyl]oxetane, 3-ethyl-3-hydroxymethyloxetane, 4,4′-bis[(3-ethyl-3-oxetanyl)methoxymethyl]biphenyl, 3-(meth)allyloxymethyl-3-ethyloxetane, (3-ethyl-3-oxetanylmethoxy)methylbenzene, (3-ethyl-3-oxetanylmethoxy)benzene, 4-fluoro-[1-(3-ethyl-3-oxetanylmethoxy)methyl]benzene, 4-methoxy-[1-(3-ethyl-3-oxetanylmethoxy)methyl]benzene, [1-(3-ethyl-3-oxetanylmethoxy)ethyl]phenyl ether, isobutoxymethyl(3-ethyl-3-oxetanylmethyl)ether, isobornyloxyethyl-(3-ethyl-3-oxetanylmethyl)ether, isobornyl(3-ethyl-3-oxetanylmethyl)ether, 2-ethylhexyl(3-ethyl-3-oxetanylmethyl)ether, ethyldiethylene glycol(3-ethyl-3-oxetanylmethyl)ether, dicyclopentadiene-(3-ethyl-3-oxetanylmethyl)ether, dicyclopentenyloxyethyl(3-ethyl-3-oxetanylmethyl)ether, dicyclopentyl(3-ethyl-3-oxetanylmethyl)ether, tetrahydrofurfuryl-(3-ethyl-3-oxetanylmethyl)ether, tetrabromophenyl(3-ethyl-3-oxetanylmethyl)ether, 2-tetrabromophenoxyethyl-(3-ethyl-3-oxetanylmethyl)ether, tribromophenyl(3-ethyl-3-oxetanylmethyl)ether, 2-tribromophenoxyethyl(3-ethyl-3-oxetanylmethyl)ether, butoxyethyl(3-ethyl-3-oxetanylmethyl)ether, pentachlorophenyl-(3-ethyl-3-oxetanylmethyl)ether, pentabromophenyl(3-ethyl-3-oxetanylmethyl)ether, bornyl-(3-ethyl-3-oxetanylmethyl)ether, 3,7-bis(3-oxetanyl)-5-oxanonan, 3,3′-[1,3-(2-methyrenyl)-propanediyl bis(oxymethylene)]-bis(3-ethyloxetane), 1,4-bis[(3-ethyl-3-oxetanylmethoxy) methyl]benzene, 1,2-bis[(3-ethyl-3-oxetanylmethoxy)methyl]ethane, 1,3-bis[(3-ethyl-3-oxetanylmethoxy)methyl]propane, ethylene glycol bis(3-ethyl-3-)oxetanylmethyl)ether, dicyclopentenyl bis(3-ethyl-3-oxetanylmethyl)ether, triethylene glycol bis(3-ethyl-3-oxetanylmethyl)ether, tetraethylene glycol bis(3-ethyl-3-oxetanylmethyl)ether, tricyclodecandyldimethylene-(3-ethyl-3-oxetanylmethyl)ether, trimethylolpropane tris(3-ethyl-3-oxetanylmethyl)ether, 1,4-bis(3-ethyl-3-oxetanylmethoxy)butane, 1,6-bis(3-ethyl-3-oxetanylmethoxy)hexane, pentaerythritol tris(3-ethyl-3-oxetanylmethyl)ether, pentaerythritol tetrakis(3-ethyl-3-oxetanylmethyl)ether, polyethylene glycol bis(3-ethyl-3-oxetanylmethyl)ether, dipentaerythritol hexax-(3-ethyl-3-oxetanylmethyl)ether, dipentaerythritol pentakis-(3-ethyl-3-oxetanylmethyl)ether, dipentaerythritol tetrakis-(3-ethyl-3-oxetanylmethyl)ether, caprolactone-modified dipentaerythritol hexaxe(3-ethyl-3-oxetanylmethyl)ether, caprolactone-modified dipentaerythritol pentakis(3-ethyl-3-oxetanylmethyl)ether, ditrimethylolpropane tetrakis(3-ethyl-3-oxetanylmethyl)ether, ethylene oxide-modified bisphenol A-bis(3-ethyl-3-oxetanylmethyl)ether, propylene oxide-modified bisphenol A-bis(3-ethyl-3-oxetanylmethyl)ether, ethylene oxide-modified hydrogenated bisphenol A-bis(3-ethyl-3-oxetanylmethyl)ether, propylene oxide-modified hydrogenated bisphenol A-bis(3-ethyl-3-oxetanylmethyl)ether, ethylene oxide-modified bisphenol F-(3-ethyl-3-oxetanylmethyl)ether, and the like.

Regarding an oxetane compound, one kind or two or more kinds thereof can be appropriately selected and used.

The vinyl ether compound is preferably a di- or tri-vinyl ether compound, and is more preferably a divinyl ether compound, from the viewpoint of curability and adhesiveness.

Examples of vinyl ether compounds include di- or tri-vinyl ether compounds such as ethylene glycol divinyl ether, diethylene glycol divinyl ether, triethylene glycol divinyl ether, propylene glycol divinyl ether, dipropylene glycol divinyl ether, butanediol divinyl ether, hexanediol divinyl ether, cyclohexanedimethanol divinyl ether, and trimethylolpropane trivinyl ether.

Examples thereof further include monovinylether compounds such as ethyl vinyl ether, n-butyl vinyl ether, isobutyl vinyl ether, octadecyl vinyl ether, cyclohexyl vinyl ether, hydroxybutyl vinyl ether, 2-ethylhexyl vinyl ether, cyclohexanedimethanol monovinyl ether, n-propyl vinyl ether, isopropyl vinyl ether, isopropenyl ether-o-propylene carbonate, dodecyl vinyl ether, diethylene glycol monovinyl ether, and octadecyl vinyl ether.

Regarding a vinyl ether compound, one kind or two or more kinds thereof can be appropriately selected and used.

An amount of the cationically polymerizable compound in the cationically polymerizable ink is not particularly limited. The amount thereof is usually 85 to 99.5 mass % and is preferably 90 to 99 mass % with respect to 100 mass % of all components other than a volatile organic solvent in the ink.

Photocationic Polymerization Initiator

As the photocationic polymerization initiator, any photocationic polymerization initiator can be used as long as it can generate a cation by irradiation with light and polymerize the above-mentioned cationically polymerizable compound. It is possible to use, for example, known photocationic polymerization initiators such as onium salts, more specifically, sulfonium salt derivatives and iodonium salt derivatives, and the like.

More specific examples of photocationic polymerization initiators include diazonium salts, iodonium salts, sulfonium salts, and the like. These are salts in which cation moieties thereof are respectively aromatic diazonium, aromatic iodonium, and aromatic sulfonium, and an anion moiety is composed of BF₄⁻, PF₆⁻, SbF₆⁻, [BX₄]⁻ (where X is a phenyl group substituted by at least two or more fluorine or trifluoromethyl groups), and the like.

Specific compounds include phenyldiazonium salts of boron tetrafluoride, diphenyliodonium salts of phosphorus hexafluoride, diphenyliodonium salts of antimony hexafluoride, tri-4-methylphenylsulfonium salts of arsenic hexafluoride, tri-4-methylphenylsulfonium salts of antimony tetrafluoride, diphenyliodonium salts of boron tetrakis(pentafluorophenyl), a mixture of acetylacetone aluminum salt and orthonitrobenzyl silyl ether, phenylthiopyridium salts, a phosphorene hexafluoride-iron complex, and the like.

Examples of commercially available photocationic polymerization initiators include CPI-100P and CPI-200K (produced by San-Apro Ltd.), WPI-113 and WPI-124 (produced by Fuji Film Wako Pure Chemical Corporation), and the like.

An amount of the photocationic polymerization initiator in the cationically polymerizable ink is not particularly limited. The amount thereof is usually 0.5 to 15 parts by mass and is preferably 1.0 to 10 parts by mass with respect to 100 parts by mass of the cationically polymerizable compound.

The cationically polymerizable ink may contain an optional component in addition to the cationically polymerizable compound and the photocationic polymerization initiator. For example, cationically polymerizable ink may contain one kind of two or more kinds of radically polymerizable compounds such as (meth)acrylate monomers or oligomers, photoradical initiators, defoamers, leveling agents, polymerization inhibitors, waxes, antioxidants, non-reactive polymers, fine particle inorganic fillers, silane coupling agents, light stabilizers, ultraviolet absorbers, antistatic agents, slip agents, solvents, and the like.

Among the above examples, the cationically polymerizable ink preferably contains a silane coupling agent from the viewpoint of improving adhesiveness.

Examples of silane coupling agents include aminosilane, epoxysilane, (meth)acrylsilane, mercaptosilane, vinylsilane, ureidosilane, sulfidesilane, and the like. In particular, epoxysilane (a compound having an epoxy group and a hydrolyzable silyl group) is preferable from the viewpoint of improving adhesiveness and compatibility with the above-described cationically polymerizable compound.

Examples of aminosilanes include bis(2-hydroxyethyl)-3-aminopropyltriethoxysilane, γ-aminopropyltriethoxysilane, γ-aminopropyltrimethoxysilane, γ-aminopropylmethyldiethoxysilane, γ-aminopropylmethyldimethoxysilane, N-β(aminoethyl) γ-aminopropyltrimethoxysilane, N-β(aminoethyl) γ-aminopropyltriethoxysilane, N-β(aminoethyl) γ-aminopropylmethyldimethoxysilane, N-β(aminoethyl) γ-aminopropylmethyldiethoxysilane, N-phenyl-γ-amino-propyltrimethoxysilane, and the like.

Examples of epoxysilanes include γ-glycidoxypropyltrimethoxysilane, γ-glycidoxypropylmethyldiethoxysilane, β-(3,4-epoxycyclohexyl)ethyltrimethoxysilane, γ-glycidylpropyltrimethoxysilane, and the like.

Examples of acrylsilanes include γ-(methacryloxypropyl)trimethoxysilane, γ-(methacryloxypropyl)methyldimethoxysilane, γ-(methacryloxypropyl)methyldiethoxysilane, and the like.

Examples of mercaptosilanes include 3-mercaptopropyltrimethoxysilane and the like.

Examples of vinyl silanes include vinyl tris(β-methoxyethoxy)silane, vinyl triethoxy silane, vinyl trimethoxy silane, and the like.

Examples of ureidosilanes include 3-ureidopropyltriethoxysilane and the like.

Examples of sulfide silanes include bis(3-(triethoxysilyl)propyl)disulfide, bis(3-(triethoxysilyl)propyl)tetrasulfide, and the like.

When the cationically polymerizable ink contains a silane coupling agent, it may contain only one kind or two or more kinds thereof.

An amount of the silane coupling agent in the cationically polymerizable ink is not particularly limited. The amount thereof is usually 0.1 to 30 mass % and is preferably 1 to 20 mass % with respect to 100 mass % of all components other than a volatile organic solvent in the ink.

Next, the radically polymerizable ink will be described.

The radically polymerizable ink typically contains a radically polymerizable monomer and a photoradical polymerization initiator.

Radically Polymerizable Monomer

Examples of radically polymerizable monomers include compounds having one or two or more polymerizable carbon-carbon double bonds in one molecule. The radically polymerizable monomer is preferably a compound having one or two or more (meth)acrylic structures in one molecule.

Examples of monofunctional monomers (compounds having only one polymerizable carbon-carbon double bond in one molecule) include methyl (meth)acrylate, ethyl (meth)acrylate, n-butyl (meth)acrylate, isobutyl (meth)acrylate, tert-butyl (meth)acrylate, 2-ethylhexyl (meth)acrylate, isodecyl (meth)acrylate, n-lauryl (meth)acrylate, n-stearyl (meth)acrylate, phenyl (meth)acrylate, benzyl (meth)acrylate, isobornyl (meth)acrylate, dimethyl (meth)acrylamide, diethyl (meth)acrylamide, di-n-propyl (meth)acrylamide, dibutyl (meth)acrylamide, and the like.

Examples of polyfunctional monomers (compounds having two or more, preferably 2 to 6 polymerizable carbon-carbon double bonds in one molecule) include bifunctional monomers such as triethylene glycol di(meth)acrylate, tetraethylene glycol di(meth)acrylate, polyethylene glycol di(meth)acrylate, tripropylene glycol di(meth)acrylate, polypropylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dimethylol-tricyclodecane di(meth)acrylate, a PO adduct di(meth)acrylate of bisphenol A, neopentyl glycol di(meth)acrylate of hydroxypivalate, polytetramethylene glycoldi(meth)acrylate, and the like.

Examples of polyfunctional monomers further include trimethylolpropane tri(meth)acrylate, pentaerythritol tri(meth)acrylate, EO-modified trimethylolpropane tri(meth)acrylate, pentaerythritol tetra(meth)acrylate, EO-modified pentaerythritol tetra(meth)acrylate, dipentaerythritol hexa(meth)acrylate, ditrimethylolpropane tetra(meth)acrylate, glycerin propoxy tri(meth)acrylate, caprolactone-modified trimethylolpropane tri(meth)acrylate, pentaerythritol ethoxy tetra(meth)acrylate, caprolactam-modified dipentaerythritol hexa(meth)acrylate, and the like.

A monomer having a polar group (for example, a phosphoric acid group or a carboxy group) may be used as a radically polymerizable monomer, from the viewpoint other than the viewpoint of the number of polymerizable functional groups.

Examples of monomers having a phosphoric acid group include 2-(meta)acryloyloxyethyl acid phosphate, di(2-methacryloyloxyethyl) acid phosphate, caprolactone modified-2-acryloyloxyethyl acid phosphate, diphenyl-2-acryloyloxyethyl phosphate, and the like.

Examples of monomers having a carboxy group include (meta)acrylic acid, crotonic acid, itaconic acid, maleic acid, fumaric acid, citraconic acid, 2-(meth)acryloyloxymethylsuccinic acid, 2-(meth)acryloyloxyethyl succinic acid, and the like.

The radically polymerizable ink may contain only one kind of radically polymerizable monomer, or may contain two or more kinds thereof. From the viewpoints of appropriate polymerizability, crosslink density, and adhesiveness, it is preferable to use, for example, a monofunctional monomer and a polyfunctional monomer in combination. From the viewpoint of adjusting adhesiveness and dispersibility of the ink, it is preferable to use a monomer having a polar group and a monomer that does not have a polar group in combination.

Photoradical Polymerization Initiator

The photoradical polymerization initiator contained in the radically polymerizable ink is not particularly limited as long as it can generate radicals by irradiation with light and polymerize the above radically polymerizable monomer.

Specific examples of photoradical polymerization initiators include α-hydroxyketone photoinitiators, α-aminoketone photoinitiators, bisacylphosphine photoinitiators, monoacylphosphine oxides, bisacylphosphine oxides such as 2,4,6-trimethylbenzoylbiphenylphosphine oxides, ethyl-2,4,6-trimethylbenzoylphenylphosphinate, mono- and bis-acylphosphine photoinitiators, benzyldimethyl-ketal photoinitiators, oligo[2-hydroxy-2-methyl-1-[4-(1-methylvinyl)phenyl]propanone], and the like.

Examples of commercially available photoradical polymerization initiators include IRGACURE (registered trademark) series produced by BASF, and the like. Other photoradical polymerization initiators can also be used.

The radically polymerizable ink may contain only one kind of photoradical polymerization initiator, or may contain two or more kinds thereof.

An amount of the radical photopolymerizable compound in the radically polymerizable ink is not particularly limited. The amount thereof is usually 0.5 to 15 parts by mass and is preferably 1.0 to 10 parts by mass with respect to 100 parts by mass of the radically polymerizable monomer.

The radically polymerizable ink may contain an optional component in addition to the radically polymerizable monomer and the photoradical polymerization initiator. As in the cationically polymerizable ink, examples of optional components include defoamers, leveling agents, polymerization inhibitors, waxes, antioxidants, non-reactive polymers, fine particle inorganic fillers, silane coupling agents, light stabilizers, ultraviolet absorbers, antistatic agents, slip agents, solvents, and the like.

The ink (which may be any of a cationically polymerizable type or an anionically polymerizable type) may contain an arbitrary colorant. As a result, design properties can be further enhanced and/or design variations can be abundant.

From the viewpoint of weather resistance and the like, a pigment is preferably used as the colorant. As the pigment, known organic pigments and/or inorganic pigments can be used.

Examples of organic pigments include soluble azo pigments such as Lake Red C and Permanent Red 2B, insoluble azo pigments such as First Yellow and Naphthol Red, condensed azo pigments such as chromophthal yellow and chromoftal red, phthalocyanine pigments such as phthalocyanine blue and phthalocyanine green, condensed polycyclic pigments such as thioindigo and perylene red, and the like.

Examples of inorganic pigments include oxide pigments such as cobalt blue, zinc white, and light red, hydroxide pigments such as viridian and alumina white, sulfide pigments such as cadmium yellow and cadmium red, silicate pigments such as ultra marine, talc, and white carbon, carbonate pigments such as silver white and calcium carbonate, carbon black, and the like.

In addition, when it is important that a finally obtained inkjet printed material exhibits “pseudo-etched texture,” it is preferable that the ink do not contain a colorant (that is, the ink is a clear ink).

A surface tension of the ink (which may be any of a cationically polymerizable type or an anionically polymerizable type) is 20 to 50 mN/m at 25° C. as described above. This value is preferably 25 to 45 mN/m, more preferably 25 to 40 mN/m, and even more preferably 25 to 35 mN/m.

Although several methods are known for measuring the surface tension, a pendant drop method is preferable. More specifically, there are two pendant drop methods, which are a ds/de method and a Young-Laplace method, and among these, a Young-Laplace method is preferable.

A viscosity of the ink (which may be any of a cationically polymerizable type or an anionically polymerizable type) is not particularly limited as long as it can form unevenness on the surface of the base material 1, but it is preferably 5 to 40 mPa·s, and is more preferably 10 to 30 mPa·s. By appropriately adjusting the viscosity of the ink, it is possible to more appropriately control the unevenness in the low glossy region, and it is possible to provide the low glossy region having higher design properties.

The viscosity can be measured under the condition of 25° C. using, for example, a cone-plate type viscometer. Examples are referred to for details of measurement conditions.

<Inkjet Printed Material>

The inkjet printed material of the present embodiment includes a low glossy region in which unevenness due to a cured product of the curable inkjet ink are present on the surface of the glossy base material.

This inkjet printed material can be usually produced by the method described in the above section <Method for producing inkjet printed material>.

This inkjet printed material has already been described with reference to FIG. 1C, but it will be described again.

The inkjet printed material shown in FIG. 1C includes the base material 1 and the low glossy region 7 in which unevenness due to a cured product of the curable ink jet ink is present (low glossy region 7) on the surface of the base material 1.

A material of the surface of the base material 1 is preferably at least one selected from the group consisting of metal, synthetic resin, glass, and glossy paper.

An arithmetic average height Sa of the low glossy region 7 defined by ISO 25178 is preferably 0.05 to 5.0 μm, more preferably 0.2 to 3.0 μm, and even more preferably 0.25 to 2.0 μm.

A maximum height Sz defined by ISO 25178 of the low glossy region 7 is 0.5 to 40 μm, is more preferably 0.5 to 30 μm, even more preferably 0.5 to 10 μm, particularly preferably 1.0 to 6.0 μm, and most preferably 1.5 to 5.0 μm.

In the low glossy region 7, dots of a cured product of inkjet ink liquid droplets are preferably present at a density of 1,000 to 100,000 dots/cm², are more preferably present at a density of 3,000 to 80,000 dots/cm², and are even more preferably present at a density of 7,000 to 60,000 dots/cm². When a density of dots is appropriate, a light scattering property is easily adjusted appropriately, and design properties can be further enhanced.

It is preferable that the cured product of the liquid droplet of the ink do not completely cover the surface of the base material in the low glossy region 7. Because the surface of the base material is exposed to some extent, design properties can be further enhanced even in the low glossy region 7.

A60-degree mirror surface gloss level ρ₁ of the low glossy region 7 is, for example, 30 to 600, preferably 40 to 500, and more preferably 100 to 400. By setting the 60-degree mirror surface gloss level ρ₁ to an appropriate value, design properties can be further enhanced.

A 60-degree mirror surface gloss level ρ₂ of the surface of the inkjet printed material on which the low glossy region 7 is not provided is larger than that of the low glossy region 7, and it is, for example, 50 to 1,000, is preferably 90 to 1,000, and is more preferably 100 to 1,000.

The 60-degree mirror surface gloss level of the base material 1 itself is not required to be within the above-mentioned numerical value range, and it is sufficient if a difference appears in glossiness between the low glossy region 7 and the other region. The 60-degree mirror surface gloss level can vary greatly depending on materials and surface properties of the base material.

From another viewpoint, the 60-degree mirror surface gloss change rate (%) obtained from {(ρ₂−ρ1)/ρ₂}×100 using the above-mentioned ρ₁ and ρ₂ is, for example, 1, to 99%, is preferably 10% to 90%, and is more preferably 20% to 85.

The low glossy region 7 (and the cured product 6 that constitutes the low glossy region 7) in the inkjet printed material of the present embodiment is usually semipermanently provided on the surface of the base material 1. The inkjet printed material of the present embodiment can be distributed as itself as a product with high design properties.

The embodiments of the present invention have been described above, but these are examples of the present invention, and various configurations other than the above embodiments can be adopted. Furthermore, the present invention is not limited to the above-described embodiments, and modifications, improvements, and the like within the scope of achieving the object of the present invention are included in the present invention.

### Examples

The embodiments of the present invention will be described in detail based on examples and comparative examples. The present invention is not limited to the examples.

I. Examples Using Cationically Polymerizable Ink

<Preparation of Cationically Polymerizable Ink>

Components shown in Table 1 were mixed and stirred with a disper to obtain a cationically polymerizable inkjet ink.

TABLE 1

| | | Content |
|---|---|---|
| Component | | (part by mass) |
| Oxetane compound | OXT-221 | 100 |
| | OXT-101 | 40 |
| Epoxy compound | CELLOXIDE 2021P | 70 |
| Silane coupling agent | GLYMO | 40 |
| Photoinitiator | CPI-100P | 10 (as amount of |
| | | active ingredient) |

Details of each of the components in the above table are as follows.
OXT-221: 3-ethyl-3{[(3-ethyloxetane-3-yl)methoxy]methyl}oxetane
OXT-101: 3-ethyl-3-hydroxymethyl oxetane (oxetane alcohol)
CELLOXIDE 2021P: 3′,4′-epoxycyclohexylmethyl-3,4-epoxycyclohexanecarboxylate
GLYMO: 3-glycidyloxypropyltrimethoxysilane
CPI-100P: a propylene carbonate solution of 50 mass % of [4-(phenylthio)phenyl]sulfonium hexafluorophosphate

A surface tension of the inkjet ink was 30 mN/m. The surface tension was measured using a contact angle meter (produced by Kyowa Interface Science Co., Ltd., model number PCA-11) under the condition of 25° C. according to a hanging drop method (pendant drop method, more specifically Young-Laplace method).

A viscosity of the above inkjet ink was 18 mPa·s. The viscosity was measured using a cone-plate type viscometer (produced by TOKI SANGYO CO., LTD, model number RE-85H) under the condition of 25° C. The measurement conditions were such that a rotation speed was 100 rpm and a cone rotor of 1°34′×R24 was used.

<Ink Applying Step>

As a base material, a stainless steel plate (SUS304 #800) that had a thickness of 1.5 mm and had been subjected to an alkali degreasing treatment was prepared. A 60-degree mirror surface gloss level of a surface of the base material itself was 610 (method of measuring the 60-degree mirror surface gloss level will be described later).

Furthermore, an inkjet printer equipped with a piezo type inkjet head produced by Konica Minolta Co., Ltd. (a product number is described in Tables 2 to 7) was prepared.

The inkjet printer was allowed to read image data “NATOCO” (alphabetic notation of the applicants of the present patent application), and the ink prepared above was jetted under the condition of a head temperature of 40° C. to apply ink liquid droplets to the base material. The application of the ink liquid droplets was performed by multi-pass printing divided into eight, and a resolution was 720×720 dpi.

A volume of the ink liquid droplets, a print density, and a dot density (density of the ink liquid droplets applied onto the base material) were set as shown in Tables 2 to 7.

The “print density” represents how many liquid droplets were ejected (jetted) with respect to a maximum number of liquid droplets (that is, resolution) ejected per unit area of the inkjet head.

The dot density is a value calculated from the resolution and the print density. For example, in the case of Example 5, the calculation was performed as follows.

Resolution (720 dpi×720 dpi)×print density 10% (0.1)=51840 dots/inch²

=8035 dots/cm²

<Curing Step>

After the ink was applied onto the base material, the ink liquid droplets applied onto the surface of the base material were cured by being irradiated with ultraviolet rays.

Specifically, a U irradiation device CoolArc CA150 (produced by Nippon Baldwin Co., Ltd.) equipped with a metal halide lamp was used, and 0.2 seconds after the ink was jetted, irradiation was performed with ultraviolet rays under the conditions of an irradiation dose of 500 mJ/cm² for each pass (UV-A conversion).

After the application of the ink liquid droplets and the irradiation of ultraviolet rays were all completed, a heat treatment was further performed at 130° C. for 10 minutes.

As described above, an inkjet printed material on which an image of the letters “NATOCO” was printed as a low glossy region was produced.

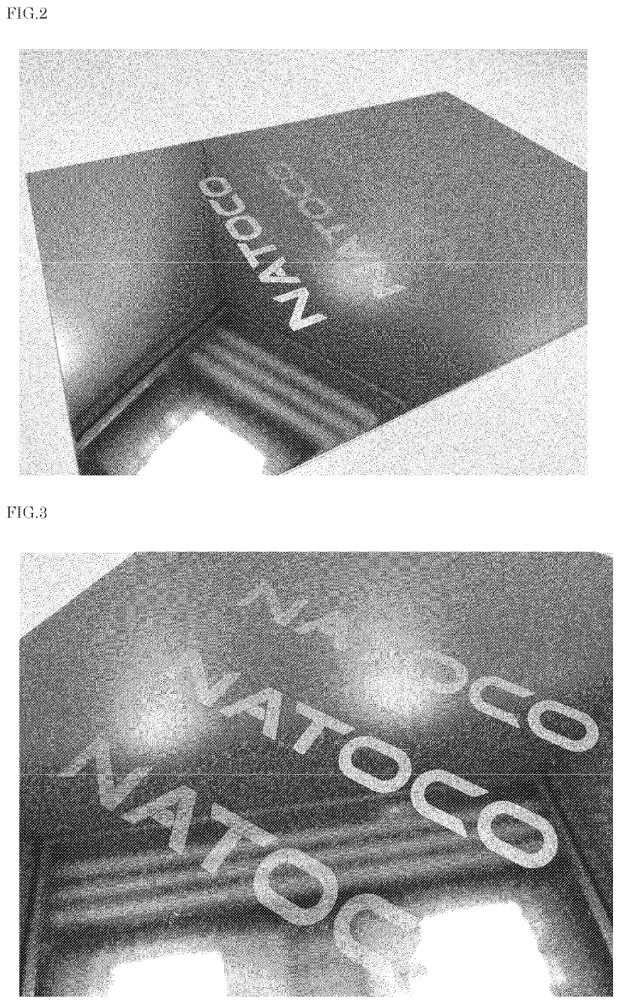

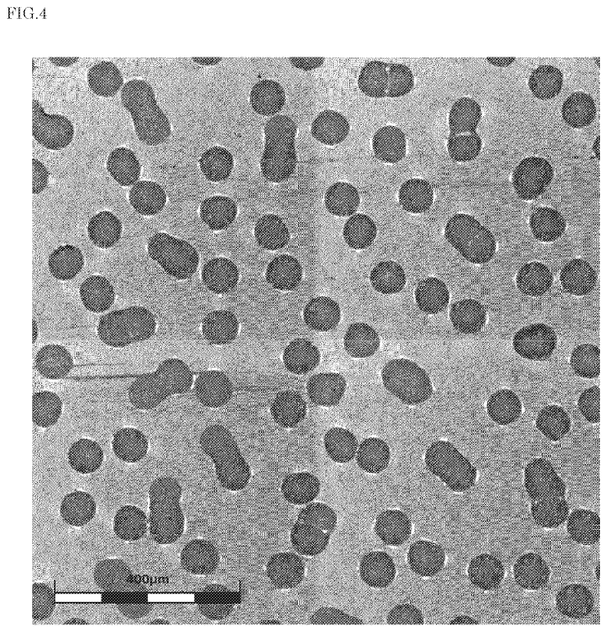

For reference, an example (photograph) of the produced inkjet printed material is shown in FIGS. 2 and 3. The design in which the letters “NATOCO” were pseudo-etched on the surface of the glossy base material can be confirmed

(in FIG. 2 and FIG. 3, the image of three letters “NATOCO” are arranged. These are the images of the letters printed under the conditions corresponding to those of Example 25, Example 22, and Example 19 in order from the top when the base material was viewed with the letters NATOCO facing in a correct direction.).

<Evaluation of Inkjet Printed Material>

[Measurement of Arithmetic Average Height Sa and Maximum Height Sz]

An arithmetic average height Sa (μm) and a maximum height Sz (μm) of the low glossy region of the obtained inkjet printed material were measured according to ISO 25178. A laser microscope OLS 4100 produced by Shimadzu Corporation was used for the measurement.

The measurement was performed under the following conditions. In addition, plane correction and isolated point removal were performed as necessary.
Objective lens of laser microscope: MPLAPON20XLENT
Measurement area: Four-screen connection range (1200 μm×1200 μm) of one field of view 644 μm×644 μm in low glossy region
Cutoff wavelength λ_{c} by Gaussian filter: 80 μm

[60-Degree Mirror Surface Gloss Level and 60-Degree Mirror Surface Gloss Change Rate]

A 60-degree mirror surface gloss level in the low glossy region was measured using a gloss meter (micro-TRI-gross produced by BYK, incident and reflection angle 60°). Furthermore, a 60-degree mirror surface gloss change rate (610) of the surface of the base material itself was calculated from the obtained measured values.

60-degree mirror surface gloss change rate (%)={(610−60-degree mirror surface gloss level of low glossy region)/610}×100

[Coverage]

First, the low glossy region was enlarged and imaged with the above laser microscope. In the photographed image, an area of the portion at which the cured product of the ink liquid droplets was reflected was obtained, divided by an area of the entire image, and multiplied by 100 to calculate a coverage (%).

[Evaluation of Pseudo-Etched Texture]

First, as a base material for reference, an actually etched metal base material was prepared.

Specifically, a stainless steel plate (SUS304 #800) having a thickness of 1.5 mm that had been subjected to an alkali degreasing treatment was prepared and put in a spray type etching apparatus. An aqueous ferric chloride solution having a liquid specific gravity of 46 Baume and a liquid temperature of 60° C. was sprayed onto the surface of the steel plate at a spray pressure of 2.5 kgf/cm² to etch about 50 μm of the surface of the steel plate. As described above, the steel plate having the etched surface (hereinafter referred to as the etched steel plate) was prepared.

The etched steel plate prepared above and the inkjet printed materials produced in Examples 1 to 45 were presented to 20 consumers unrelated to the applicants, and a questionnaire survey was conducted based on the following criteria as to how a sensation of the inkjet printed materials produced in Examples 1 to 45 was as compared to the etched steel plate.

The scores given by 20 consumers were totaled for each of the examples, and results are shown in Tables 1 to 3. As a total score becomes higher, the evaluation becomes higher.

| | |
|---|---|
| An etched sensation was felt | 2 points |
| An etched sensation was slightly felt | 1 point |
| An etched sensation was hardly felt | 0 points |

Tables 2 to 7 collectively show the print conditions and the evaluation results of the inkjet printed materials.

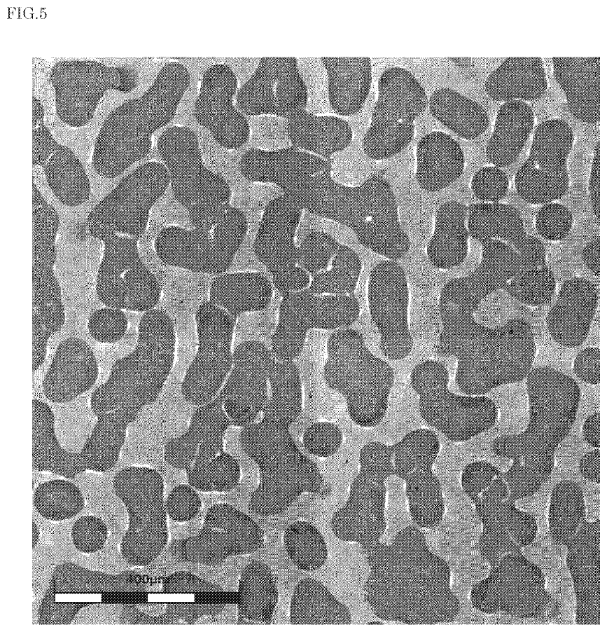

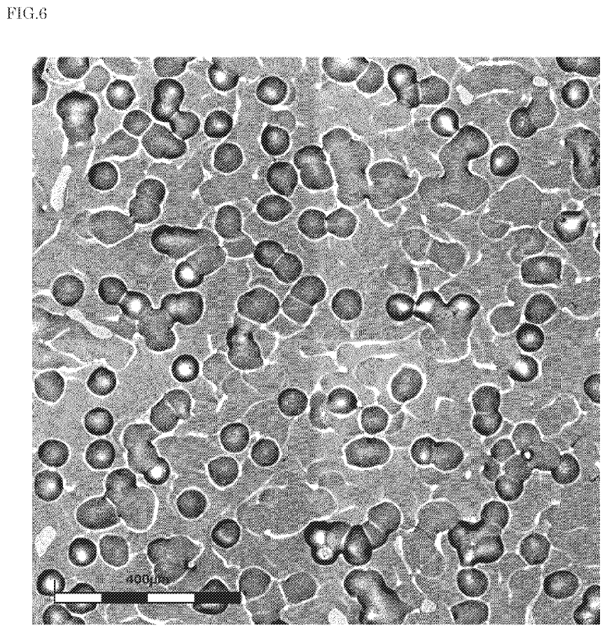

Furthermore, for reference, enlarged images of the “low glossy region” of the inkjet printed materials obtained in Examples 19, 22, and 27 are shown in FIGS. 4 to 6.

TABLE 2

| No. | | | Example 1 | Example 2 | Example 3 | Example 4 | Example 5 | Example 6 | Example 7 | Example 8 |
|---|---|---|---|---|---|---|---|---|---|---|
| Printing | Types of head | | KM1024SHB | KM1024SHB | KM1024SHB | KM1024SHB | KM1024SHB | KM1024SHB | KM1024SHB | KM1024SHB |
| condition | Volume of liquid | | 6 | 6 | 6 | 6 | 6 | 6 | 6 | 6 |
| | droplet (pL) | | | | | | | | | |
| | Printing | | 2 | 4 | 6 | 8 | 10 | 15 | 20 | 30 |
| | concentration (%) | | | | | | | | | |
| | Density of dots | | 1607 | 3214 | 4821 | 6428 | 8035 | 12053 | 16070 | 24106 |
| | (dots/cm²) | | | | | | | | | |
| Evaluation | Sa | Arithmetic | 0.082 | 0.121 | 0.189 | 0.234 | 0.246 | 0.318 | 0.335 | 0.395 |
| of | | average | | | | | | | | |
| printed | | height (μm) | | | | | | | | |
| material | Sz | Maxium | 2.806 | 4.206 | 4.557 | 3.437 | 4.695 | 4.877 | 6.228 | 3.958 |
| | | height (μm) | | | | | | | | |

| | | | | | | | | |
|---|---|---|---|---|---|---|---|---|
| Mirror surface | 590 | 560 | 533 | 506 | 493 | 449 | 404 | 328 |
| gloss level | | | | | | | | |
| (60 °) | | | | | | | | |
| Mirror surface | 3.3 | 8.2 | 12.6 | 17.0 | 19.2 | 26.4 | 33.8 | 46.2 |
| gloss change | | | | | | | | |
| rate (%) | | | | | | | | |
| Coverage (%) | 3.8 | 8.2 | 12.9 | 15.7 | 20.2 | 27.7 | 35.3 | 49.4 |
| Evaluation of | 19 | 20 | 23 | 27 | 33 | 36 | 37 | 39 |
| pseudo-ectched | | | | | | | | |
| sensation | | | | | | | | |

TABLE 3

| No. | | | Example 9 | Example 10 | Example 11 | Example 12 | Example 13 | Example 14 | Example 15 |
|---|---|---|---|---|---|---|---|---|---|
| Printing | Types of head | | KM1024SHB | KM1024SHB | KM1024SHB | KM1024SHB | KM1024SHB | KM1024SHB | KM1024SHB |
| condition | Volume of liquid | | 6 | 6 | 6 | 6 | 6 | 6 | 6 |
| | droplet (pL) | | | | | | | | |
| | Printing | | 40 | 50 | 60 | 70 | 80 | 90 | 100 |
| | concentration (%) | | | | | | | | |
| | Density of dots | | 32141 | 40176 | 48211 | 56246 | 64282 | 72317 | 80352 |
| | (dots/cm²) | | | | | | | | |
| Evaluation | Sa | Arithmetic | 0.386 | 0.370 | 0.449 | 0.401 | 0.316 | 0.313 | 0.336 |
| of | | average | | | | | | | |
| printed | | height (μm) | | | | | | | |
| material | Sz | Maxium | 3.855 | 4.384 | 4.569 | 3.453 | 4.732 | 3.992 | 4.162 |
| | | height (μm) | | | | | | | |

| | | | | | | | |
|---|---|---|---|---|---|---|---|
| Mirror surface | 325 | 256 | 227 | 193 | 168 | 152 | 140 |
| gloss level | | | | | | | |
| (60 °) | | | | | | | |
| Mirror surface | 46.7 | 58.0 | 62.8 | 68.4 | 72.5 | 75.1 | 77.0 |
| gloss change | | | | | | | |
| rate (%) | | | | | | | |
| Coverage (%) | 58.9 | 70.8 | 74.0 | 77.7 | 82.4 | 87.8 | 89.9 |
| Evaluation of | 39 | 40 | 40 | 43 | 40 | 40 | 40 |
| pseudo-ectched | | | | | | | |
| sensation | | | | | | | |

TABLE 4

| No. | | | Example 16 | Example 17 | Example 18 | Example 19 |
|---|---|---|---|---|---|---|
| Printing | Types of head | | KM1024MHB | KM1024MHB | KM1024MHB | KM1024MHB |
| condition | Volume of | | 14 | 14 | 14 | 14 |
| | liquid | | | | | |
| | droplet (pL) | | | | | |
| | Printing | | 2 | 4 | 6 | 8 |
| | concentration | | | | | |
| | (%) | | | | | |
| | Density | | 1607 | 3214 | 4821 | 6428 |
| | of dots | | | | | |
| | (dots/cm²) | | | | | |
| Evaluation | Sa | Arithmetic | 0.051 | 0.080 | 0.109 | 0.150 |
| of | | average | | | | |
| printed | | height (μm) | | | | |
| material | Sz | Maxium | 1.706 | 1.931 | 2.460 | 2.045 |
| | | height | | | | |
| | | (μm) | | | | |
| | Mirror | | 567 | 512 | 471 | 434 |
| | surface | | | | | |
| | gloss level | | | | | |
| | (60 °) | | | | | |
| | Mirror | | 7.0 | 16.1 | 22.8 | 28.9 |
| | surface | | | | | |
| | gloss change | | | | | |
| | rate (%) | | | | | |
| | Coverage (%) | | 6.1 | 13.7 | 20.9 | 28.1 |
| | Evaluation | | 22 | 23 | 25 | 29 |
| | of pseudo-ectched | | | | | |
| | sensation | | | | | |
| No. | | | Example 20 | Example 21 | Example 22 | Example 23 |
| Printing | Types of head | | KM1024MHB | KM1024MHB | KM1024MHB | KM1024MHB |
| condition | Volume of | | 14 | 14 | 14 | 14 |
| | liquid | | | | | |
| | droplet (pL) | | | | | |
| | Printing | | 10 | 15 | 20 | 30 |
| | concentration | | | | | |
| | (%) | | | | | |
| | Density | | 8035 | 12053 | 16070 | 24106 |
| | of dots | | | | | |
| | (dots/cm²) | | | | | |
| Evaluation | Sa | Arithmetic | 0.162 | 0.160 | 0.160 | 0.169 |
| of | | average | | | | |
| printed | | (μm) | | | | |
| material | Sz | Maxium | 2.229 | 2.211 | 1.939 | 2.339 |
| | | height | | | | |
| | | (μm) | | | | |

| | | | | |
|---|---|---|---|---|
| Mirror | 395 | 313 | 255 | 184 |
| surface | | | | |
| gloss level | | | | |
| (60 °) | | | | |
| Mirror | 35.2 | 48.7 | 58.2 | 69.8 |
| surface | | | | |
| gloss change | | | | |
| rate (%) | | | | |
| Coverage (%) | 35.0 | 48.4 | 62.2 | 73.0 |
| Evaluation | 35 | 38 | 39 | 40 |
| of pseudo-ectched | | | | |
| sensation | | | | |

TABLE 5

| No. | | | Example 24 | Example 25 | Example 26 | Example 27 | Example 28 | Example 29 | Example 30 |
|---|---|---|---|---|---|---|---|---|---|
| Printing | Types of head | | KM1024MHB | KM1024MHB | KM1024MHB | KM1024MHB | KM1024MHB | KM1024MHB | KM1024MHB |
| condition | Volume of liquid | | 14 | 14 | 14 | 14 | 14 | 14 | 14 |
| | droplet (pL) | | | | | | | | |
| | Printing | | 40 | 50 | 60 | 70 | 80 | 90 | 100 |
| | concentration (%) | | | | | | | | |
| | Density of dots | | 32141 | 40176 | 48211 | 56246 | 64282 | 72317 | 80352 |
| | (dots/cm²) | | | | | | | | |
| Evaluation | Sa | Arithmetic | 0.164 | 0.159 | 0.157 | 0.204 | 0.273 | 0.244 | 0.249 |
| of | | average | | | | | | | |
| printed | | height (μm) | | | | | | | |
| material | Sz | Maxium | 3.694 | 2.640 | 2.611 | 2.272 | 3.007 | 3.707 | 3.234 |
| | | height (μm) | | | | | | | |

| | | | | | | | |
|---|---|---|---|---|---|---|---|
| Mirror surface | 137 | 108 | 83 | 64 | 51 | 43 | 41 |
| gloss level | | | | | | | |
| (60 °) | | | | | | | |
| Mirror surface | 77.5 | 82.3 | 86.5 | 89.5 | 91.6 | 93.0 | 93.2 |
| gloss change | | | | | | | |
| rate (%) | | | | | | | |
| Coverage (%) | 80.8 | 88.7 | 97.0 | 98.7 | 99.2 | 99.5 | 99.9 |
| Evaluation of | 40 | 39 | 31 | 30 | 27 | 27 | 26 |
| pseudo-ectched | | | | | | | |
| sensation | | | | | | | |

TABLE 6

| No. | | | Example 31 | Example 32 | Example 33 | Example 34 | Example 35 | Example 36 | Example 37 | Example 38 |
|---|---|---|---|---|---|---|---|---|---|---|
| Printing | Types of head | | KM1024LHB | KM1024LHB | KM1024LHB | KM1024LHB | KM1024LHB | KM1024LHB | KM1024LHB | KM1024LHB |
| condition | Volume of liquid | | 42 | 42 | 42 | 42 | 42 | 42 | 42 | 42 |
| | droplet (pL) | | | | | | | | | |
| | Printing | | 2 | 4 | 6 | 8 | 10 | 15 | 20 | 30 |
| | concentration (%) | | | | | | | | | |
| | Density of dots | | 1607 | 3214 | 4821 | 6428 | 8035 | 12053 | 16070 | 24106 |
| | (dots/cm²) | | | | | | | | | |
| Evaluation | Sa | Arithmetic | 0.090 | 0.227 | 0.262 | 0.343 | 0.364 | 0.406 | 0.307 | 0.355 |
| of | | average | | | | | | | | |
| printed | | height (μm) | | | | | | | | |
| material | Sz | Maxium | 2.922 | 5.394 | 5.204 | 4.455 | 4.643 | 4.299 | 4.996 | 4.200 |
| | | height (μm) | | | | | | | | |

| | | | | | | | | |
|---|---|---|---|---|---|---|---|---|
| Mirror surface | 561 | 522 | 474 | 432 | 398 | 328 | 273 | 222 |
| gloss level | | | | | | | | |
| (60 °) | | | | | | | | |
| Mirror surface | 8.0 | 14.4 | 22.3 | 29.2 | 34.8 | 46.2 | 55.2 | 63.6 |
| gloss change | | | | | | | | |
| rate (%) | | | | | | | | |
| Coverage (%) | 11.7 | 21.5 | 34.8 | 39.6 | 48.4 | 64.9 | 69.9 | 82.2 |
| Evaluation of | 27 | 32 | 35 | 37 | 36 | 35 | 32 | 28 |
| pseudo-ectched | | | | | | | | |
| sensation | | | | | | | | |

TABLE 7

| No. | | | Example 39 | Example 40 | Example 41 | Example 42 | Example 43 | Example 44 | Example 45 |
|---|---|---|---|---|---|---|---|---|---|
| Printing | Types of head | | KM1024LHB | KM1024LHB | KM1024LHB | KM1024LHB | KM1024LHB | KM1024LHB | KM1024LHB |
| condition | Volume of liquid | | 42 | 42 | 42 | 42 | 42 | 42 | 42 |
| | droplet (pL) | | | | | | | | |
| | Printing | | 40 | 50 | 60 | 70 | 80 | 90 | 100 |
| | concentration (%) | | | | | | | | |
| | Density of dots | | 32141 | 40176 | 48211 | 56246 | 64282 | 72317 | 80352 |
| | (dots/cm²) | | | | | | | | |
| Evaluation | Sa | Arithmetic | 0.304 | 0.247 | 0.171 | 0.166 | 0.105 | 0.104 | 0.101 |
| of | | average | | | | | | | |
| printed | | height (μm) | | | | | | | |
| material | Sz | Maxium | 4.839 | 4.455 | 7.096 | 3.361 | 3.620 | 3.800 | 4.517 |
| | | height (μm) | | | | | | | |

| | | | | | | | |
|---|---|---|---|---|---|---|---|
| Mirror surface | 164 | 132 | 115 | 102 | 102 | 110 | 121 |
| gloss level | | | | | | | |
| (60 °) | | | | | | | |
| Mirror surface | 73.1 | 78.4 | 81.1 | 83.3 | 83.3 | 82.0 | 80.2 |
| gloss change | | | | | | | |
| rate (%) | | | | | | | |
| Coverage (%) | 92.5 | 96.1 | 97.1 | 99.5 | 99.9 | 100.0 | 100.0 |
| Evaluation of | 26 | 22 | 18 | 17 | 14 | 14 | 14 |
| pseudo-ectched | | | | | | | |
| sensation | | | | | | | |

As shown in Tables 2 to 7, it was possible to obtain an inkjet printed material having a low glossy region (there is unevenness due to a cured product of the ink) on the surface of the base material by an ink applying step of applying a liquid droplet of the curable inkjet ink in which a surface tension at 25° C. is 20 to 50 mN/m onto a surface of the glossy base material, and a curing step of curing the ink liquid droplet which has been applied onto the surface of base material.

That is, it is possible to provide a new method for producing a base material including a low glossy region by printing an ink composition on a surface of the glossy base material. This method does not require a plate. Accordingly, this producing method is suitable, for example, for producing small amounts of many types of base material.

Furthermore, changes in the mirror surface gloss level is substantially correlated with the print density and the dot density. Based on the above description, it was understood that the gloss level can be freely changed to some extent by appropriately changing the conditions for ink jetting.

Furthermore, based on the overall comparison of Examples 1 to 15 (liquid droplet volume 6 pL), Examples 16 to 30 (liquid droplet volume 14 pL), and Examples 31 to 45 (liquid droplet volume 42 pL), it was found that when a liquid droplet volume is somewhat small, it can be read that it is easier to obtain a pseudo-etched pattern having high design properties.

II. Examples Using Radically Polymerizable Ink

<Preparation of Radically Polymerizable Ink>

Components shown in Table 8 were mixed and stirred with a disper to obtain a radically polymerizable inkjet ink.

TABLE 8

| | | Content |
|---|---|---|
| Component | | (part by mass) |
| Acrylate compound | 1,6-Hexanediol diacrylate | 100 |
| | Trimethylolpropane triacrylate | 10 |
| Photopolymerization | Omnirad 184 | 4 |
| initiator | | |

In the above table, Omnirad 184 is an IGM Resins produced by B.V., 1-hydroxycyclohexyl phenyl ketone (100% active ingredient).

A surface tension of the inkjet ink was 35 mN/m. The measurement was performed using a contact angle meter (produced by Kyowa Interface Science Co., Ltd., model number PCA-11) under the condition of 25° C. according to a hanging drop method (pendant drop method, more specifically Young-Laplace method).

A viscosity of the above inkjet ink was 25 mPa·s. The measurement was performed using a cone-plate type viscometer (produced by TOKI SANGYO CO., LTD, model number RE-85H) under the condition of 25° C. The measurement conditions were such that a rotation speed was 100 rpm and a cone rotor of 1° 34′×R24 was used.

<Ink Applying Step>

A stainless steel plate similar to that of the example of the above section I. in which the cationically polymerizable ink was used was prepared.

Furthermore, an inkjet printer equipped with a piezo type inkjet head produced by Konica Minolta Co., Ltd. (a product number is described in Tables 9 and 10) was prepared.

The inkjet printer was allowed to read image data “NATOCO” (alphabetic notation of the applicants of the present patent application), and the ink prepared above was jetted under the condition of a head temperature of 40° C. to apply ink liquid droplets to the base material. The application of the ink liquid droplets was performed by multi-pass printing divided into eight, and a resolution was 720×720 dpi.

A volume of the ink liquid droplets, a print density, and a dot density (density of the ink liquid droplets applied onto the base material) were set as shown in Tables 9 and 10.

Definitions of the “print density” and the “dot density” are the same as those in the above section I.

<Curing Step>

After the ink was applied onto the base material, the ink liquid droplets applied onto the surface of the base material were cured by being irradiated with ultraviolet rays.

Specifically, a UV irradiation device CoolArc CA150 (produced by Nippon Baldwin Co., Ltd.) equipped with a metal halide lamp was used, and 0.2 seconds after the ink was jetted, irradiation was performed with ultraviolet rays under the conditions of an irradiation dose of 500 mJ/cm² for each pass (UV-A conversion).

After the application of the ink liquid droplets and the irradiation of ultraviolet rays were all completed, a heat treatment was further performed at 130° C. for 10 minutes.

As described above, an inkjet printed material on which an image of the letters “NATOCO” was printed as a low glossy region was produced.

<Evaluation of Inkjet Printed Material>

In the same manner as in the above section I., Sa (μm), Sz (μm), a 60-degree mirror surface gloss level, a 60-degree mirror surface gloss change rate, and a coverage were measured. In addition, the same manner as in the above section I., pseudo-etched texture was evaluated.

Tables 9 and 10 collectively show the print conditions and the evaluation results of the inkjet printed materials.

TABLE 9

| No. | | | Example 2-1 | Example 2-2 | Example 2-3 | Example 2-4 |
|---|---|---|---|---|---|---|
| Printing | Types of head | | KM1024iMHE | KM1024iMHE | KM1024iMHE | KM1024iMHE |
| condition | Volume of | | 13 | 13 | 13 | 13 |
| | liquid | | | | | |
| | droplet (pL) | | | | | |
| | Printing | | 2 | 4 | 6 | 8 |
| | concentration | | | | | |
| | (%) | | | | | |
| | Density | | 1607 | 3214 | 4821 | 6428 |
| | of dots | | | | | |
| | (dots/cm²) | | | | | |
| Evaluation | Sa | Arithmetic | 0.056 | 0.109 | 0.146 | 0.194 |
| of | | average | | | | |
| printed | | height (μm) | | | | |
| material | Sz | Maxium | 4.555 | 4.818 | 5.633 | 7.898 |
| | | height (μm) | | | | |
| | Mirror surface | | 570 | 502 | 479 | 430 |
| | gloss level | | | | | |
| | (60 °) | | | | | |
| | Mirror surface | | 6.6 | 17.7 | 21.5 | 29.5 |
| | gloss change | | | | | |
| | rate (%) | | | | | |
| | Coverage (%) | | 6.2 | 15.2 | 22.0 | 29.5 |
| | Evaluation of | | 20 | 22 | 23 | 30 |
| | pseudo-ectched | | | | | |
| | sensation | | | | | |
| No. | | | Example 2-5 | Example 2-6 | Example 2-7 | Example 2-8 |
| Printing | Types of head | | KM1024iMHE | KM1024iMHE | KM1024iMHE | KM1024iMHE |
| condition | Volume of | | 13 | 13 | 13 | 13 |
| | liquid | | | | | |
| | droplet (pL) | | | | | |
| | Printing | | 10 | 15 | 20 | 30 |
| | concentration | | | | | |
| | (%) | | | | | |
| | Density | | 8035 | 12053 | 16070 | 24106 |
| | of dots | | | | | |
| | (dots/cm2) | | | | | |
| Evaluation | Sa | Arithmetic | 0.218 | 0.291 | 0.340 | 0.454 |
| of | | average | | | | |
| printed | | height (μm) | | | | |
| material | Sz | Maxium | 8.873 | 6.742 | 11.375 | 16.403 |
| | | height (μm) | | | | |

| | | | | |
|---|---|---|---|---|
| Mirror surface | 380 | 321 | 260 | 191 |
| gloss level | | | | |
| (60 °) | | | | |
| Mirror surface | 37.7 | 47.4 | 57.4 | 68.7 |
| gloss change | | | | |
| rate (%) | | | | |
| Coverage (%) | 33.7 | 47.1 | 57.3 | 79.1 |
| Evaluation of | 32 | 35 | 37 | 40 |
| pseudo-ectched | | | | |
| sensation | | | | |

TABLE 10

| No. | | | Example 2-9 | Example 2-10 | Example 2-11 | Example 2-12 | Example 2-13 | Example 2-14 | Example 2-15 |
|---|---|---|---|---|---|---|---|---|---|
| Printing | Types of head | | KM1024iMHE | KM1024iMHE | KM1024iMHE | KM1024iMHE | KM1024iMHE | KM1024iMHE | KM1024iMHE |
| condition | Volume of liquid | | 13 | 13 | 13 | 13 | 13 | 13 | 13 |
| | droplet (pL) | | | | | | | | |
| | Printing | | 40 | 50 | 60 | 70 | 80 | 90 | 100 |
| | concentration (%) | | | | | | | | |
| | Density of dots | | 32141 | 40176 | 48211 | 56246 | 64282 | 72317 | 80352 |
| | (dots/cm²) | | | | | | | | |
| Evaluation | Sa | Arithmetic | 0.498 | 0.549 | 0.605 | 0.644 | 0.615 | 0.686 | 0.712 |
| of | | average | | | | | | | |
| printed | | height (μm) | | | | | | | |
| material | Sz | Maxium | 23.635 | 14.201 | 19.223 | 28.470 | 31.969 | 26.743 | 32.489 |
| | | height (μm) | | | | | | | |

| | | | | | | | |
|---|---|---|---|---|---|---|---|
| Mirror surface | 140 | 104 | 80 | 71 | 55 | 48 | 45 |
| gloss level | | | | | | | |
| (60 °) | | | | | | | |
| Mirror surface | 77.0 | 83.0 | 86.9 | 88.4 | 91.0 | 92.1 | 92.6 |
| gloss change | | | | | | | |
| rate (%) | | | | | | | |
| Coverage (%) | 89.4 | 94.0 | 97.3 | 98.6 | 97.4 | 99.1 | 99.0 |
| Evaluation of | 40 | 40 | 35 | 30 | 27 | 27 | 25 |
| pseudo-ectched | | | | | | | |
| sensation | | | | | | | |

As shown in Tables 9 and 10, even when a radically polymerizable ink was used as the curable inkjet ink instead of the cationically polymerizable ink, it was possible to obtain an inkjet printed material having a low glossy region on the surface of the base material.

In comparison with Tables 2 to 7, a difference is particularly seen in values of Sz. In Tables 2 to 7, a maximum value of Sz is about 5 μm, but in Tables 9 and 10, Sz is equal to or more than 32 μm in some cases. From the viewpoint of reducing a “rough sensation” of the surface, it may be preferable to use a cationically polymerizable ink as the inkjet ink.

A relatively high Sz in Tables 9 and 10 can be interpreted that liquid droplets were cured in a “stacked up” state when the radically polymerizable ink was used.

This application claims the priority on the basis of Japanese application Japanese Patent Application No. 2018-089342 filed May 7, 2018, the entire disclosure of which is incorporated herein by reference.

### REFERENCE SIGNS LIST

1: base material (glossy base material)
3: inkjet head
5: liquid droplet (liquid droplet of curable inkjet ink)
6: cured product (cured product of curable inkjet ink)
7A: ink applied region
7: low glossy region

1. A method for producing an inkjet printed material in which a low glossy region having unevenness due to a cured product of a curable inkjet ink is provided on a surface of a glossy base material, the method comprising:
an ink applying step of applying a liquid droplet of the curable inkjet ink in which a surface tension at 25° C. is 20 to 50 mN/m onto a surface of the base material; and
a curing step of curing the liquid droplet of the ink which has been applied onto the surface,
wherein the low glossy region is formed by the ink applying step and the curing step,
wherein the curable inkjet ink is a photocurable type,
wherein the curing step is a light irradiation step of irradiating the liquid droplet of the ink applied onto the surface with light,
wherein a time from the application of the liquid droplet onto the surface of the base material in the ink applying step to start of the light irradiation step is 0.1 to 3.0 seconds,
wherein the cured product of the liquid droplet covers 30 to 80% of the surface of the base material in the low glossy region, and
wherein a material of the surface of the base material is metal.

2-3. (canceled)

4. The method for producing an inkjet printed material according to claim 1,
wherein an accumulated light amount of the radiated light is 50 to 10,000 mJ/cm².

5. The method for producing an inkjet printed material according to claim 1,
wherein an arithmetic average height Sa defined by ISO 25178 of the low glossy region is 0.05 to 5.0 μm.

6. The method for producing an inkjet printed material according to claim 1,
wherein a maximum height Sz defined by ISO 25178 of the low glossy region is 0.5 to 40 μm.

7. The method for producing an inkjet printed material according to claim 1,
wherein in the ink applying step, the liquid droplet of the ink is applied onto the base material at a density of 1,000 to 100,000 droplets/cm².

8. The method for producing an inkjet printed material according to claim 1,
wherein a viscosity of the curable inkjet ink is 5 to 40 mPa·s.

9. The method for producing an inkjet printed material according to claim 1,
wherein the curable inkjet ink is a cationically polymerizable type.

10. The method for producing an inkjet printed material according to claim 1,
wherein a volume of the liquid droplet of the ink in the ink applying step is 2 to 50 pL.

11-12. (canceled)

13. The method for producing an inkjet printed material according to claim 1,
wherein the low glossy region has an appearance of pseudo-etched texture.

14. An inkjet printed material,
wherein a low glossy region having unevenness due to a cured product of a curable inkjet ink is provided on a surface of a glossy base material,
wherein the cured product of the liquid droplet covers 30 to 80% of the surface of the base material in the low glossy region, and
wherein a material of the surface of the base material is metal.

15. The inkjet printed material according to claim 14,
wherein an arithmetic average height Sa defined by ISO 25178 of the low glossy region is 0.05 to 5.0 μm.

16. The inkjet printed material according to claim 14,
wherein a maximum height Sz defined by ISO 25178 of the low glossy region is 0.5 to 30 μm.

17. The inkjet printed material according to claim 14,
wherein dots of the cured product of the liquid droplet of the inkjet ink are present in the low glossy region at a density of 1,000 to 100,000 dots/cm².

18-19. (canceled)

20. The inkjet printed material according to claim 14,
wherein a 60-degree mirror surface gloss change rate (%) obtained from {(ρ₂−ρ₁)/ρ₂}×100 is 1% to 99%, where ρ₁ represents a 60-degree mirror surface gloss level ρ₁ of the low glossy region, and ρ₂ represents a 60-degree mirror surface gloss level ρ₂ of a surface of the base material on which the low glossy region is not provided.
